(19) United States
(12) Patent Application Publication
(10) Pub. No.: US 2025/0068966 A1
(43) Pub. Date: Feb. 27, 2025

(54) HUMAN-IN-THE-LOOP TASK AND MOTION PLANNING FOR IMITATION LEARNING

(71) Applicant: NVIDIA Corporation, Santa Clara, CA (US)

(72) Inventors: Ajay Uday MANDLEKAR, Cupertino, CA (US); Caelan Reed GARRETT, Seattle, WA (US); Danfei XU, Atlanta, GA (US); Dieter FOX, Seattle, WA (US)

(73) Assignee: NVIDIA Corporation, Santa Clara, CA (US)

(21) Appl. No.: 18/456,030

(22) Filed: Aug. 25, 2023

(51) Int. Cl. G06N 20/00

(52) U.S. Cl. CPC G06N 20/00

(57) ABSTRACT

In various examples, systems and methods are disclosed relating to training machine learning models using human demonstration of segments of a task, where other segments of the task are performed by a planning method, such as a Task and Motion Planning (TAMP) system. A method may include segmenting a task to be performed by a robot into segments, determining a first set of instructions of a plurality of sets of instructions for operating the robot to perform a first objective of a first segment, determining that the plurality of sets of instructions is inadequate to perform a second objective of a second segment, receiving from a user device a second set of instructions for operating the robot for the second segment following an end of the first segment, and updating a machine learning model for controlling the robot using the second set of instructions for the second segment.

### BACKGROUND

Imitation learning is a method for training robots or other autonomous systems complex manipulation skills using human demonstration of those skills. However, imitation learning does not scale well, as providing long manipulation demonstrations is time-consuming and labor intensive.

### SUMMARY

Embodiments of the present disclosure relate to training (e.g., updating one or more parameters—such as weights and biases—of) and deploying a machine learning model using imitation learning to, for example, perform a segment of a task. For example, systems and methods are disclosed that enable breaking a task into segments, identifying segments for which imitation learning is needed, and requesting human demonstration for those segments.

Combining robotic motion planning methods with imitation learning allows robots to accomplish tasks beyond the scope of planning methods while greatly improving training throughput relative to imitation learning of entire tasks. Conventional robotic motion planning methods generally require accurate dynamics models and precise perception, which are often unavailable, limiting their effectiveness at contact-rich and low-tolerance manipulation. Systems can plan behavior for a wide range of multi-step manipulation tasks by searching over valid combinations of a small number of primitive skills. Traditionally, each skill is hand-engineered; however, certain skills, such as closing a spring-loaded lid or inserting a rod into a hole, are prohibitively difficult to model in a productive manner.

The embodiments discussed herein provide for training machine learning models to execute sets of instructions to provide for or fine-tune lacking skills. By training machine learning models to execute skills which planning methods do not provide while allowing the planning methods to execute skills of which the planning methods are capable, the embodiments herein provide the benefits of both imitation learning and planning methods. The planning methods can incorporate the machine learning models to supplement their existing skills with skills provided by the machine learning models trained by imitation learning, and the imitation learning can be limited to those skills or segments of tasks which cannot be performed using the existing skills of the planning methods. This greatly reduces the amount of human demonstration required relative to conventional imitation learning, reducing the time and burden upon human operators and increasing throughput of training.

In example implementations, a processor (e.g., one or more processors or processing units) includes one or more circuits to segment a task to be performed by a robot into segments. The one or more circuits may, for each of the segments, select a set of instructions of a plurality of sets of instructions to be applied and apply the selected set of instructions to each segment to enable the robot to perform a portion of the task, wherein one or more sets of instructions of the selected sets of instructions are executed by a machine learning model, and wherein the machine learning model has been trained. The training may include, for one iteration of performing the task, applying a first set of instructions of the plurality of sets of instructions to move the robot for a first segment of the segments, requesting human demonstration of a second set of instructions of the plurality of sets of instructions, and updating the second set of instructions based on the human demonstration.

The plurality of sets of instructions may include coordinates and vectors for controlling the robot. The machine learning model may be trained to execute the second set of instructions based on a determination that a subset of the plurality of sets of instructions is inadequate to perform an objective of the second segment, wherein the objective includes moving an object from a first pose to a second pose. The subset of the plurality of sets of instructions may be inadequate to perform the objective based on the subset of the plurality of sets of instructions being inadequate to control the robot to move the object from the first pose to the second pose within a predetermined period of time. The subset of the plurality of sets of instructions may be inadequate to perform the objective based on the subset of the plurality of sets of instructions being inadequate to control the robot to move the object from the first pose to the second pose without contacting a second object. The subset of the plurality of sets of instructions may be inadequate to perform the objective based on the subset of the plurality of sets of instructions being inadequate to control the robot to move the object from the first pose to the second pose with a predetermined level of precision. For the first segment of the one iteration, human demonstration may or may not be requested. The selected set of instructions may include a transition pose for transitioning to the second set of instructions executed by the machine learning model. The one or more transition poses may be determined by mapping the segments to a human demonstration of the task and identifying one or more poses of the robot at a portion of the human demonstration corresponding to a transition from the first segment to the second segment.

In example implementations, a processor may include one or more circuits to segment a task to be performed by a robot into segments, determine a first set of instructions of a plurality of sets of instructions for operating the robot to perform a first objective of a first segment of the segments, determine that the plurality of sets of instructions is inadequate to perform a second objective of a second segment of the segments, send to a user device of an operator a request for human demonstration of the second segment, receive from the user device a second set of instructions for operating the robot for the second segment following an end of the first segment, and update a machine learning model controlling the robot using the second set of instructions for the second segment. The plurality of sets of instructions may coordinates and vectors for controlling the robot. The second objective may include moving an object from a first pose to a second pose. The plurality of sets of instructions may be inadequate to perform the second objective based on the plurality of sets of instructions being inadequate to control the robot to move the object from the first pose to the second pose within a predetermined period of time. The plurality of sets of instructions may be inadequate to perform the second objective based on the plurality of sets of instructions being inadequate to control the robot to move the object from the first pose to the second pose without contacting a second object. The plurality of sets of instructions may be inadequate to perform the second objective based on the plurality of sets of instructions being inadequate to control the robot to move the object from the first pose to the second pose with a predetermined level of precision. The one or more circuits may send the request for human demonstration of the second segment by adding the second segment to a queue of segments for which demonstration is requested. The queue of segments may be associated with a human operator, and the one or more circuits may add the second segment to the queue of segments based at least on an expected throughput of the human operator. The first objective of the first segment may include reaching a transition pose for transitioning between the first segment and the second segment. The transition pose may be determined by mapping the segments to a human demonstration of the task and identifying one or more poses of the robot at a apportion of the human demonstration corresponding to a transition from the first segment to the second segment. The segments may include a plurality of transition poses for transitioning to segments associated with human demonstrations.

### BRIEF DESCRIPTION OF THE DRAWINGS

The present systems and methods for training and deploying a machine learning model using imitation learning are described in detail below with reference to the attached drawing figures, wherein:

FIG. 1 is a block diagram of an example system, in accordance with at least some embodiments of the present disclosure;

FIG. 2 is a block diagram of an example task segmentation, in accordance with at least some embodiments of the present disclosure;

FIG. 3 depicts an example performance of a segmented task, in accordance with at least some embodiments of the present disclosure;

FIG. 4 is a flow diagram of an example process for training a machine learning model, in accordance with at least some embodiments of the present disclosure;

FIG. 5 depicts an example queuing system for human demonstration, in accordance at least some embodiments of the present disclosure;

FIG. 6 illustrates an example bootstrapping process for determining transition poses between planning methods and human demonstration, in accordance with at least some embodiments of the present disclosure; and

FIG. 7 is a flowchart illustrating operations of an example method for training a machine learning model, in accordance with at least some embodiments of the present disclosure.

FIG. 8 illustrates example pseudocode, in accordance with at least some embodiments of the present disclosure.

### DETAILED DESCRIPTION

Systems and methods are disclosed related to training and deploying a machine learning model using imitation learning to, for example, perform one or more segments of a task.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, generative AI applications, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implementing one or more language models-such as one or more large language models (LLMs), systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

Learning from human demonstrations has emerged as a promising way to teach robots complex manipulation skills. However, scaling up the paradigm of learning from human demonstrations to real-world long-horizon tasks has been difficult—e.g., because providing long manipulation demonstrations is time-consuming and labor intensive. At the same time, not all parts of a task are equally challenging. For example, significant portions of complex manipulation tasks such as part assembly or making a cup of coffee are free-space motion and object transportation, which can be readily automated by non-learning approaches such as motion planning. However, planning methods generally require accurate dynamics models and precise perception, which are often unavailable, limiting the effectiveness of planning methods for contact-rich and low-tolerance manipulation. The embodiments discussed herein solve real-world long-horizon manipulation tasks by combining the benefits of learning and planning approaches.

Some embodiments discussed herein augment motion planning methods, such as Task and Motion Planning (TAMP) systems, which have been shown to be remarkable at solving long-horizon problems. Although various embodiments are discussed in relation to TAMP systems, other planning methods can be used interchangeably. TAMP methods can plan behavior for a wide range of multi-step manipulation tasks by searching over valid combinations of a small number of primitive skills. Traditionally, each skill is hand-engineered; however, certain skills, such as closing a spring-loaded lid or inserting a rod into a hole, are prohibitively difficult to model in a productive manner. Some embodiments discussed herein use a combination of human teleoperation and closed-loop learning to implement just these select skills (skills that are difficult to implement using TAMP systems), keeping the rest automated (e.g., performed by the TAMP system). These skills use human teleoperation at data collection time and a policy or machine learning model trained from the data at deployment time.

Some embodiments discussed herein are directed to Human-in-the-Loop TAMP (HITL-TAMP), a system that symbiotically combines TAMP with teleoperation (human demonstration). The system collects demonstrations by employing a TAMP-gated control mechanism—the system trades off control between a TAMP system and a human teleoperator, who takes over to fill in gaps that TAMP delegates. Human operators only need to engage at selected steps of a task plan when prompted by the TAMP system, meaning that the human operators can manage a fleet of robots by asynchronously engaging with one demonstration session at a time while a TAMP system controls the rest of the fleet.

By soliciting human demonstrations only when needed, and allowing for a human to participate in multiple parallel sessions, embodiments discussed herein greatly increase the throughput of data collection while lowering the effort needed to collect large datasets on long-horizon, contact-rich tasks. The data collection system of collecting human demonstrations can be combined with an imitation learning framework that trains a TAMP-gated policy on the collected human data. This combination leads to superior performance compared to collecting human demonstrations on the entire task, in terms of the amount of data and time needed for a human to teach a task to the robot, as well as the success rate of machine learning models.

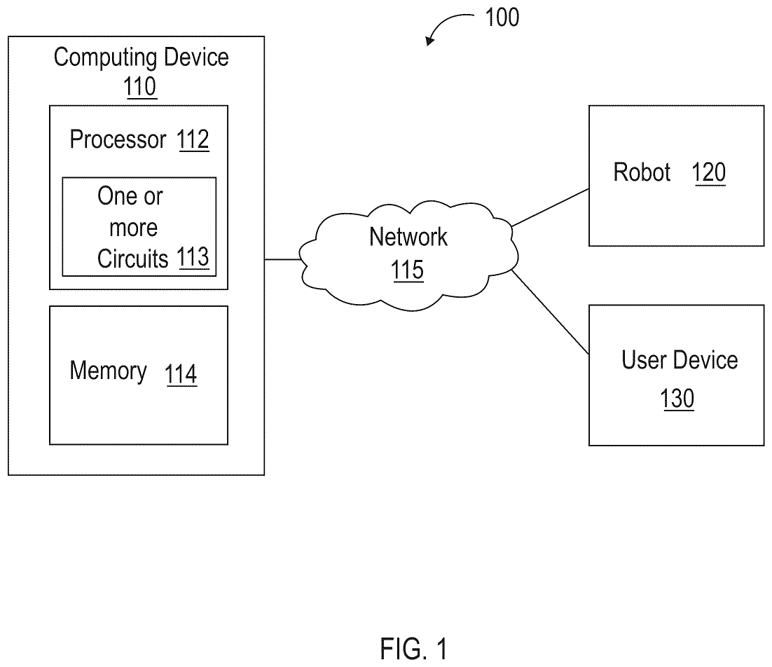

FIG. 1 is a block diagram of an example system 100, in accordance with at least some embodiments of the present disclosure. The system 100 may include, among additional or alternative components, a computing device 110, a network 115, a robot 120, and a user device 130.

The computing device 110 may include a processor(s) 112 and a memory(ies) 114. The memory 114 may be a non-transitory medium including computer-readable instructions which, when executed by one or more processors, such as the processor 112, cause the processor to perform one or more functions described herein. The memory 114 may be a hard drive, an SSD, RAM, a buffer, a cache, or any other storage device. The memory 114 may include one or more storage devices. The processor 112 may include one or more circuits 113. The one or more circuits 113 may be configured to execute instructions, such as instructions stored in the memory 114, to perform various functions.

The network 115 may be or include a wide area network (WAN), local area network (LAN), cellular network, and/or any kind of network. In an example, the network 115 is the Internet.

The robot 120 may be a robot configured to perform one or more tasks. The robot 120 may include one or more sensors. In an example, the robot 120 includes one or more cameras, one or more LiDAR sensors, one or more RADAR sensors, one or more ultrasonic sensors, and/or one or more other sensor types or modalities. The robot 120 may include one or more motors and one or more manipulation devices, such as grippers or claws. The robot 120 may include a memory(ies) and a processor(s) for storing and executing instructions. The robot 120 may include a communications interface for receiving instructions via the network 115.

The user device 130 may be device for use by a human operator. The user device 130 may include a display. The user device 130 may include a user interface for receiving user input, such as a mouse and/or keyboard or a touchscreen. The user device 130 may be a laptop, smartphone, desktop computer, or any other device for displaying information and receiving input.

The computing device 110 may send instructions to the robot 120 via the network 115. The computing device 110 may send coordinates and vectors for controlling the robot 120 to the robot 120 via the network. The computing device 110 may send a request for human demonstration of a task or a segment of a task to the user device 130 via the network 115. The computing device 110 may segment a task to be performed by the robot into segments, as discussed herein, where each segment may have an associated objective. The objective may include at least one of changing the pose of at least one part of the robot and/or changing the pose of at least one object. In an example, the objective may be one of 1) moving a portion of the entirety of the robot from an original pose to a new pose, 2) moving two or more portions of the robot (e.g., different robotic manipulators, segments, members) from original poses to new poses, 3) moving an object other than the robot from an original pose to a new pose, 4) picking up, engaging, or interacting with an object, 5) releasing an object, (6) causing an interaction between a first object and a second object, and/or (7) altering an object. A pose may include at least one of position or orientation. Subsequent segments may have different objectives and different types of objectives. In an example, a first segment has an objective of moving a manipulator of a robot into position to grasp an object and a second segment has an objective of moving the object from an original pose to a new pose.

The computing device 110 may select one or more skills or sets of instructions stored in the memory 114 or the memory of the robot 120 for performing a first objective of a first segment of the task. The computing device 110 may determine that the skills or sets of instructions stored in the memory 114 or the memory of the robot 120 are insufficient to perform a second objective of a second segment of the task. The computing device 110 may send a request for a human demonstration of the second segment of the task to the user device 130. The user device 130 may receive input from a human operator to control the robot 120 to demonstrate the second segment. The computing device 110 may train a machine learning model based on the human demonstration of the second segment. The computing device 110 may store the machine learning model to perform the second segment. The computing device 110 may access the machine learning model to perform the second segment of the task.

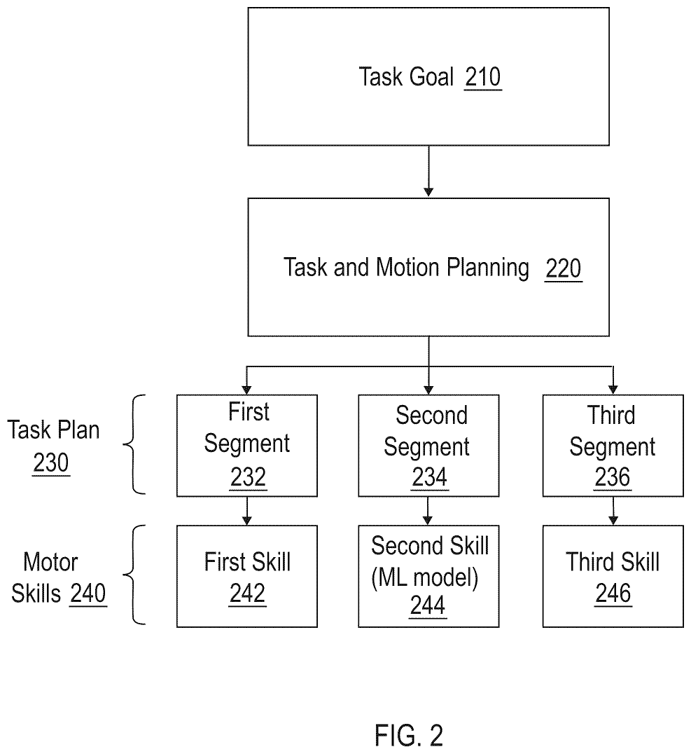

FIG. 2 is a block diagram of an example task segmentation in accordance with at least some embodiments of the present disclosure. The task segmentation may be performed by the system 100 of FIG. 1 or by one or more components of the system 100, such as the computing device 110 of FIG. 1. The task may include and/or be defined by a task goal 210. A TAMP system 220 may generate a task plan 230 based on the task goal 210. Although a TAMP system is discussed herein, other motion planning systems may be used. The task plan 230 may include segments, each associated with an objective. The task plan 230 may include a first segment 232, a second segment 234, and a third segment 236. The first segment 232 may be associated with a first objective, the second segment 234 may be associated with a second objective, and the third segment 236 may be associated with a third objective. The first, second, and third objectives, when performed, may amount to performance of the task goal 210.

Each of the first segment 232, the second segment 234, and the third segment 236 may be associated with a skill, or set of instructions for accomplishing the corresponding objective. The TAMP system 220 may associate the first segment 232, the second segment 234, and the third segment 236 with a skill, or set of instructions. The TAMP system 220 may associate the first segment 232, the second segment 234, and the third segment 236 with the corresponding skill, or set of instructions based on the skill or set of instructions being adequate to accomplish the corresponding objective. The first segment 232 may be associated with a first skill 242, the second segment 234 may be associated with a second skill 244, and the third segment 236 may be associated with a third skill 246. The first skill 232, the second skill 244, and the third skill 246, referred to herein collectively as motor skills 240, may be sets of instructions for operating the robot 120 of FIG. 1.

The TAMP system 220 may select the first skill 242 and the third skill 246 from a plurality of skills or sets of instructions. The plurality of skills or sets of instructions may be stored in the memory 114 of FIG. 1. The TAMP system 220 may determine that the plurality of skills or sets of instructions is inadequate to perform the objective of the second segment 234. The TAMP system 220 may request human demonstration of the second segment 234 to train a machine learning model to execute the second skill 244, as discussed herein. The second skill 244 may be added to the plurality of skills or sets of instructions for use by the TAMP system 220. During deployment, the TAMP system 220 may apply the motor skills 240 to the corresponding segments to enable the robot to accomplish the task goal 210.

In some implementations, the TAMP system 220 may receive input from a user to break the task goal 210 into the task plan 230 and to determine which of the first segment 232, the second segment 234, and the third segment 236 can be performed by the plurality of skills or sets of instructions, and which require training of a machine learning model using human demonstration.

In some implementations, the TAMP system 220 may determine which of the first segment 232, the second segment 234, and the third segment 236 can be performed by the plurality of skills or sets of instructions, and which require training of a machine learning model using human demonstration by attempting to apply one or more candidate skills to the second segment 234 to accomplish the second objective and determining that the one or more candidate skills are inadequate to accomplish the second objective. In some implementations, the TAMP system 220 may determine that the plurality of skills is inadequate by attempting to apply the one or more candidate skills to the second segment 234 in a simulation. The simulation may include a 3D simulation of the robot, a workspace, and one or more objects for completing the task. In an example, the second objective is to move an object from a first pose to a second pose. The plurality of skills may be inadequate based on the plurality of sets of instructions being inadequate to control the robot to move the robot to move the object from the first pose to the second pose within a predetermined period of time. The plurality of skills may be inadequate based on the plurality of sets of instructions being inadequate to control the robot to move the robot to move the object from the first pose to the second pose without contacting a second object. The plurality of skills may be inadequate based on the plurality of sets of instructions being inadequate to control the robot to move the robot to move the object from the first pose to the second pose with a predetermined level of precision.

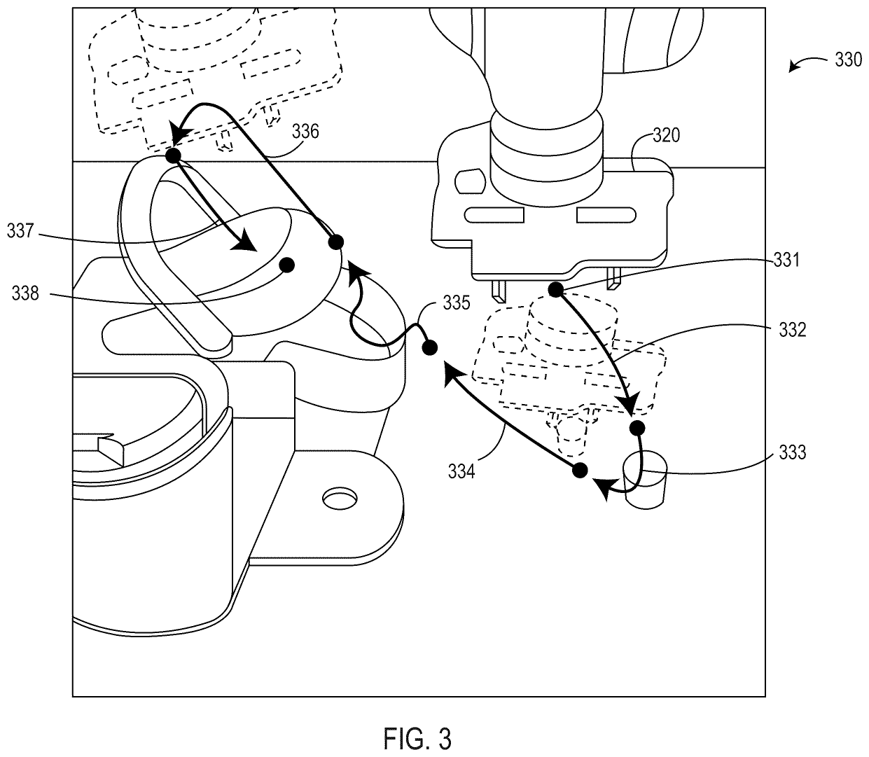

FIG. 3 depicts an example performance of a segmented task 330 in accordance with at least some embodiments of the present disclosure. The task 330 may be performed by the system 100 of FIG. 1 using a motion planning system such as the TAMP system 220 of FIG. 2. The task 330 may include a start condition 331 and an end condition 338. The starting condition 331 and/or the end condition 338 may be defined by a task goal, such as the task goal 210 of FIG. 2. The task 330 may be broken into segments by a TAMP system, such as the TAMP system 220 of FIG. 2. The task 330 may include a first segment 332, a second segment 333, a third segment 334, a fourth segment 335, a fifth segment 336, and a seventh segment 337.

The start condition 331 may be a starting pose of a robot 320 performing the task 330 and/or one or more objects. The start condition 331 may be loosely defined based on one or more start parameters. The one or more start parameters can vary to allow for flexibility in starting the task 331. In an example, the start condition 331 may include the robot 320 posed above a coffee pod on a table next to a coffee machine. The end condition 338 may be an ending pose of the robot 320 and/or the one or more objects. In an example, the end condition 338 may include the coffee pod inserted inside of the coffee machine with a lid of the coffee machine closed over the coffee pod.

The first segment 332 may be performed by the TAMP system using one or more skills of a plurality of available skills. The TAMP system may have determined that the plurality of available skills are adequate to perform the first segment 332. However, the TAMP system may have determined that the plurality of available skills are inadequate to perform the second segment 333. During training, the second segment 333 may be performed by a human operator providing a human demonstration of the second segment 333. The TAMP system may request the human demonstration of the second segment 33. The human demonstration of the second segment 333 may be used to train a first machine learning model to perform the second segment 333. During deployment, the first machine learning model may be used to perform the second segment 333.

An end pose of the robot 320 for the first segment 332 may be based on a transition pose for transitioning between the first segment 332 and the second segment 333 and for transitioning between control of the robot 320 provided by the TAMP system and control of the robot 320 provided by the human operator. An end pose of the second segment 333 may be defined as a pose from which the TAMP system can successfully control the robot 320. The end pose of the second segment 333 may prompt the TAMP system to regain control of the robot 320 to perform the third segment 334. The TAMP system may perform the third segment 334, request a human demonstration of the fourth segment 335, perform the fifth segment 336, and request a human demonstration of the sixth segment 337. The human demonstrations of the fourth segment 335 and the sixth segment 337 may be used to train a second machine learning model and a third machine learning model, respectively. During deployment, the second machine learning model may be used to perform the fourth segment 335 and the third machine learning model may be used to perform the sixth segment 337. In some examples, two or more of the first, second, and third machine learning models are a single machine learning model trained to perform two or more corresponding segments.

During training, control of the robot 320 is passed between the TAMP system and the human operator to perform the task 330. During deployment, control of the robot 320 is passed between the TAMP system and the machine learning models trained used the human demonstrations to perform the task 330. The TAMP system may select the machine learning models similar to how the TAMP system selects skills for performance of segments. In this way, the machine learning models may be integrated into the TAMP system to supplement the skills of the TAMP system. Training and/or deployment may be performed in virtual or physical spaces.

The task 330 may include any number of segments. Although segments are shown as alternating between control by the TAMP system and control by the human operator, any number of subsequent segments may be performed by the TAMP system or by the human operator. The human demonstrations, although discussed as being provided by a single human operator, may be provided by multiple different human operators. In some embodiments, in addition to or alternatively from using a human operator to teach/perform a segment or skill, another robot or computing program previously trained on the skill or segment may be used to teach the current robot/machine learning model the skill/segment. In this way, the learning from the another robot or computing program may be transferred to the current robot/machine learning model to enable another skill of the robot/machine learning model.

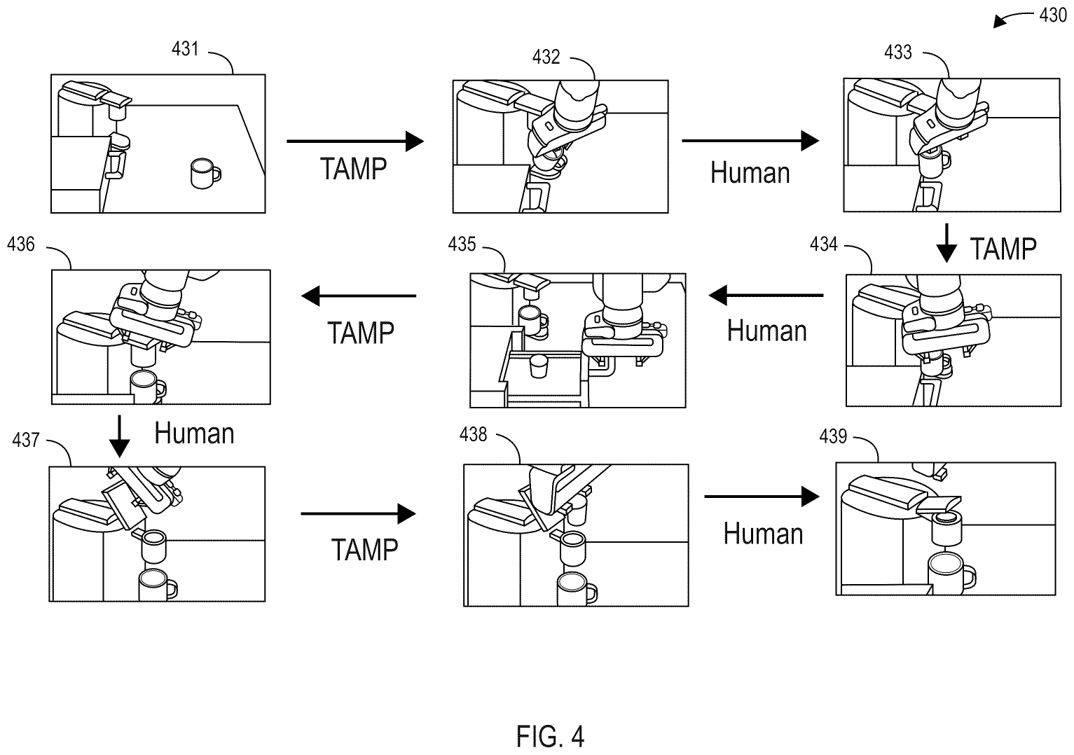

FIG. 4 is a flow diagram 430 of an example process for training a machine learning model in accordance with at least some embodiments of the present disclosure. Different segments of a task performed by a robot may be performed by a TAMP system or a human operator, as discussed in conjunction with FIG. 3.

Different states of the task, corresponding to objectives of the segments of the task, may represent different transition points between control of the robot by the TAMP system and control of the robot by the human operator. A starting state of a first segment 431 may be a start condition of the task, similar to the start condition 331 of FIG. 3. An end state 439 of an eight segment 438 may be an end condition of the task, similar to the end condition 338 of FIG. 3.

The TAMP system may perform the first segment 431. The first segment 431 may include a first transition pose of the robot and/or one or more objects for a transition of control from the TAMP system to the human operator. The human operator may perform a second segment 432. The second segment 432 may include a second transition pose of the robot and/or the one or more objects for a transition of control from the human operator to the TAMP system. The first transition pose may be defined by various poses of the robot and/or the one or more objects from which the human operator can successfully perform the second segment 432, as discussed herein. The second transition pose may be defined by various poses of the robot and/or the one or more objects from which the TAMP system can successfully perform a third segment 433. The human operator may perform a fourth segment 434. The TAMP system may perform a fifth segment 435. The human operator may perform a sixth segment 436. The TAMP system may perform a seventh segment 437. The human operator may perform the eighth segment 438 to achieve the end condition 439. Each of the segments may include a transition pose, as discussed herein.

In an example, the robot must place a mug onto a coffee machine, retrieve a coffee pod from a drawer, insert the pod into the machine, and close the lid. The task has 8 segments—first the TAMP system grasps the mug and approaches the placement location, then the human (or, once trained, the machine learning model) places the mug on the coffee machine (the placement requires precision due to the arm size and space constraints). Next, the TAMP system approaches the machine lid, and the human (or, once trained, the machine learning model) opens the lid (requires extended contact with an articulated mechanism). Then, the TAMP system approaches the drawer handle, and the human (or, once trained, the machine learning model) opens the drawer. Finally, the TAMP system grasps the pod from inside the drawer and approaches the machine, and the human (or, once trained, the machine learning model) inserts the pod and closes the machine lid.

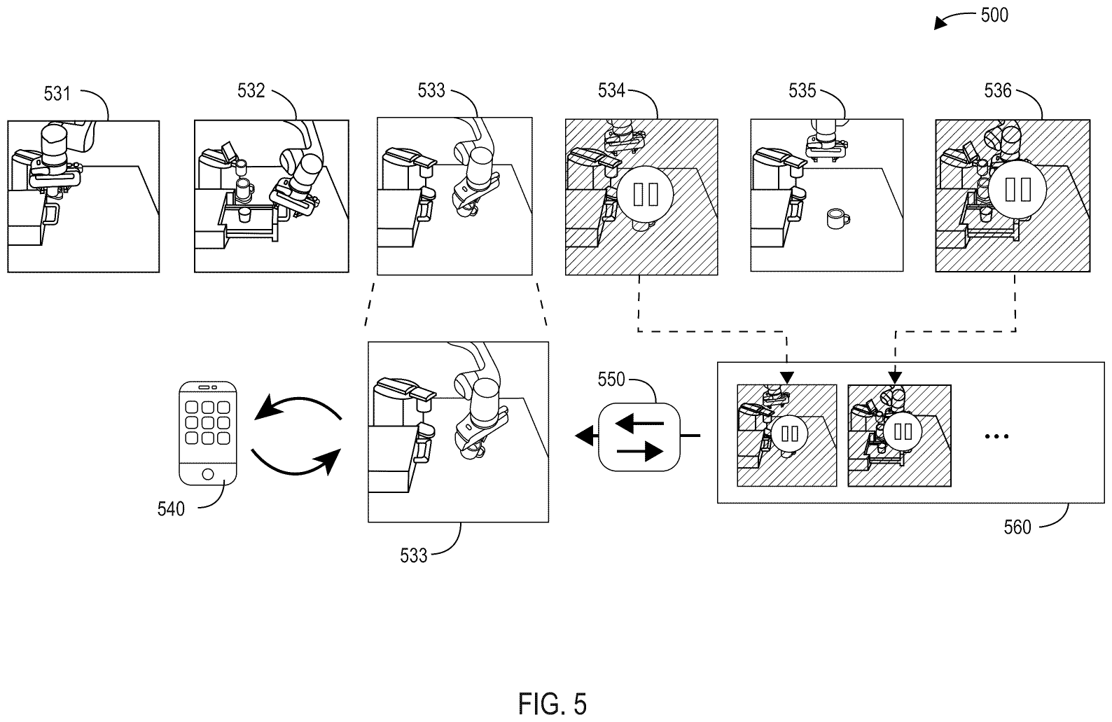

FIG. 5 depicts an example queuing system 500 for human demonstration in accordance at least some embodiments of the present disclosure. The queuing system 500 may be embodied in hardware, software, or a combination of hardware and software. The queueing system 500 may be part of or executed on the system 100.

The queuing system 500 may include a control switch 550 which switches control from a TAMP system to a human operator. The queueing system 500 may include a user device 540. The user device 540 may be the user device 130 of FIG. 1. The human operator may input commands to a robot using the user device 540. The queueing system 500 may select one or more segments for human demonstration from a plurality of segments of a task, such as a first segment 531, a second segment 532, a third segment 533, a fourth segment 534, a fifth segment 535, and a sixth segment 536. The queuing system 500 may select the third segment 533, the fourth segment 534, and the sixth segment 536 for human demonstration. When a human demonstration of the third task 533 is being performed, the fourth segment 534 and the sixth segment 536 may be placed in a queue 560 for human demonstration of the fourth segment 534 and the sixth segment 536. When the human demonstration of the third segment 533 has been performed, the switch 550 may grant control to the user device 540 to perform a human demonstration of the fourth task 534. When the human demonstration of the fourth segment 534 has been performed, the switch 550 may grant control to the TAMP system to execute the fifth segment 535. When the TAMP system has executed the fifth segment 535, the switch may grant control to the user device 540 to perform a human demonstration of the sixth segment 536.

In some implementations, the TAMP system places segments in the queue 560 based on the segments requiring human demonstration. In some implementations, the queue 560 receives segments from multiple TAMP systems concurrently. In this way, the human operator can perform human demonstrations for segments of multiple tasks. This may reduce downtime of the human operator between human demonstrations and increase a throughput of the human demonstrations. The shared queue 560 may allow the human operator to provide more human demonstrations of segments of tasks.

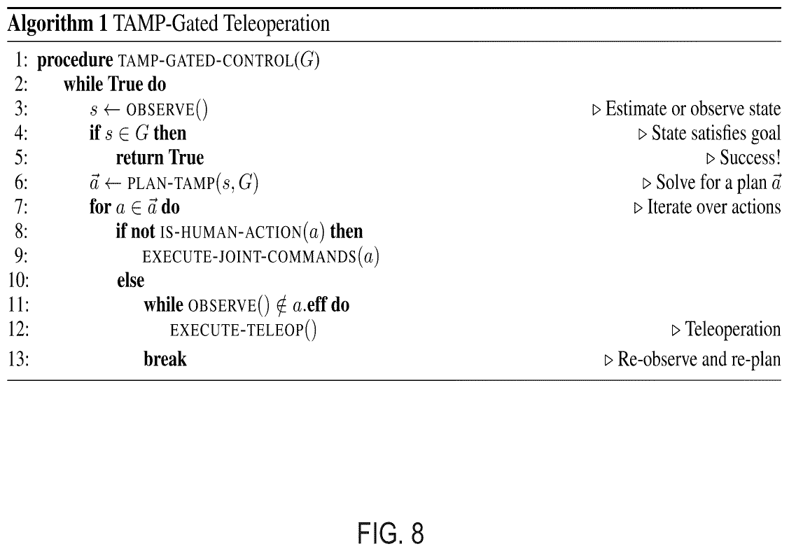

In an example, each task of a plurality of tasks is defined by a goal formula G. On each TAMP iteration, the TAMP system observes the current state s. If the current state s satisfies G the episode terminates, otherwise, the TAMP system solves for a plan \vec{a} from the current state s to the goal G. The TAMP system subsequently issues joint pose commands to carry out planned motions until reaching an action a requiring human demonstration. Next, control switches into teleoperation mode, where the human has full 6-degree-of-freedom control of the end effector of the robot. The robot end effector is controlled using an Operational Space Controller. The TAMP system monitors whether the state s satisfies the planned action postconditions a.effects. Once satisfied, control switches back to the TAMP system, which replans. An example of pseudocode for this process is shown in FIG. 8.

In an example, the queuing system 500 is used to increase a throughput of human demonstrations for training one or more machine learning models to perform segments of tasks. Since the TAMP system only requires human assistance in small parts of a task, a human operator has the opportunity to manage multiple robots and data collection sessions simultaneously. To this end, the queuing system 500 allows each operator to interact with a fleet of robots. This may be implemented by using several (N_{robot}) robot processes, a single human process, and the queue 560. Each robot process runs asynchronously, and spends its time in 1 of 3 modes—(1) being controlled by the TAMP system, (2) waiting for human control, or (3) being controlled by the human. This allows the TAMP system to operate multiple robots in parallel. When the TAMP system wants to prompt the human for control, the TAMP system enqueues the environment into the shared queue 560. The human process communicates with the human user device and sends control commands from the user device to one robot process at a time. When the human operator completes a segment, the TAMP system resumes control of the robot, and the human process dequeues the next session from the queue 560.

In some implementations, the queue 560 receives segments based on an expected throughput of the human operator. The expected throughput may be referred to as an average queue consumption rate. Assuming that the human operator has an average queue consumption rate (number of task demonstrations completed per unit time) of R_{H} and the TAMP system has an average queue production rate (number of task segments executed successfully per unit time) of R_{T}, the effective rate of production should match or exceed the rate of consumption as in expression (1):

$${R}_{T} ( {N}_{robot} - 1 ) \geq {R}_{H} . \qquad ( 1 )$$

In expression (1), the minus 1 is because one robot is controlled by the human. Rearranging expression (1) results in expression (2):

$${N}_{robot} \geq 1 + \frac{{R}_{H}}{{R}_{T}} . \qquad ( 2 )$$

Thus, the size of the fleet should be at least one more than the ratio between the human rate of producing demonstration segments and the TAMP rate of solving and executing segments. This number is often limited by either the amount of system resources (in simulation) or the availability of hardware (in real world). In practice, human operators also need to take breaks and have an effective “duty cycle” where the human operators are kept busy X % of the time. Embodiments discussed herein can support this extension (accounting for duty cycles) as well. Assume that a human operator is operating the system for Tₒₙ and resting for T_{off}, the human operator consumes items in the queue during Tₒₙ at an effective rate of R_{H}−R_{T}(N_{robot}−1), and has the queue filled up during T_{off} at a rate of R_{T}(N_{robot}−1). In some examples, expression (3) is used to ensuring that the human consumption rate is less than or equal to the production rate:

$${N}_{robot} {T}_{off} {R}_{T} ( Nrobot - 1 ) . \qquad ( 3 )$$

Rearranging expression (3) results in expression (4):

$${N}_{robot} \geq 1 + \frac{{R}_{H}}{{R}_{T}} \frac{X}{100} . \qquad ( 4 )$$

In expression (4), X, the human duty cycle ratio, is defined as in expression (5):

$$\frac{X}{100} = \frac{{T}_{on}}{( {T}_{on} + {T}_{off} )} . \qquad ( 5 )$$

Embodiments described herein result in task performances that include TAMP-controlled segments and human-controlled segments. Machine learning models may be trained, such as with Behavioral Cloning, on the human-controlled segments. To deploy the trained machine learning model, a TAMP-gated control loop may be used that is identical to the handoff logic used for giving control to the human operator, using the policy instead of the human. Thus, instead of passing control to the human operator, the TAMP system may pass control to the trained machine learning model.

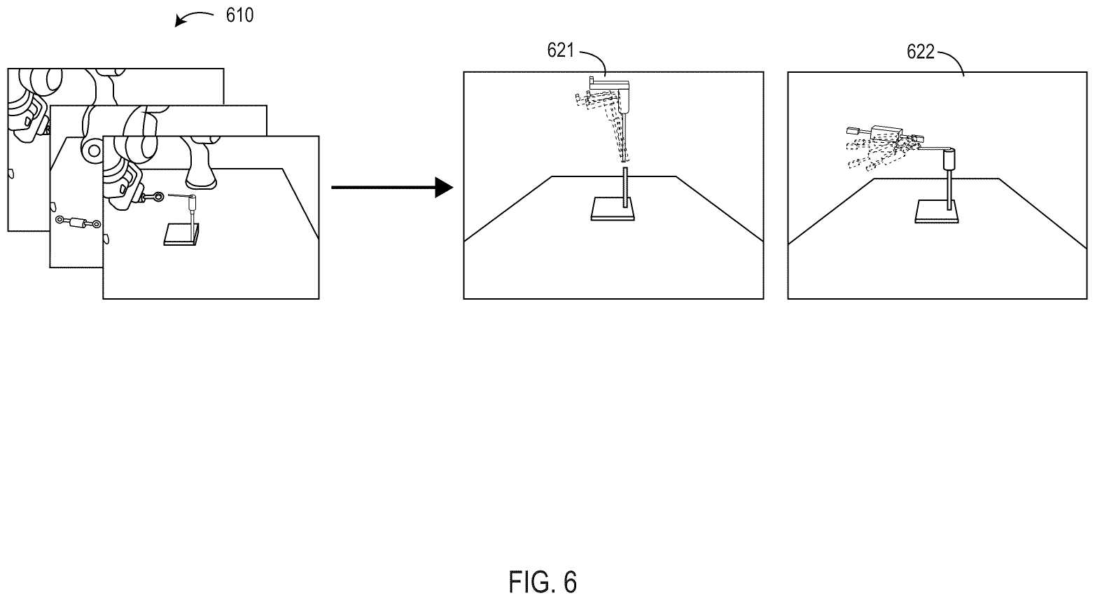

FIG. 6 illustrates an example bootstrapping process for determining transition poses between planning methods and human demonstration in accordance with at least some embodiments of the present disclosure. As discussed herein, segments of a task include one or more transition poses for passing control between a TAMP system and a human operator. In some implementations, the TAMP system determines at least one transition pose for passing control to the human operator for a first segment 621 and at least one transition pose for passing control to the human operator for a second segment 622 based on a set of human demonstrations 610 of the task. In an example, the set of human demonstrations may include 1-5 human demonstrations of the task. The TAMP system may determine the transition poses from the set of human demonstrations such that the human operator can successfully control the robot for the human-controlled segments. In an example, a human operator provides a set of demonstrations of a tool hang task so the TAMP system can bootstrap one or more transition poses for transferring control to the human operator for selected segments, as discussed herein.

### Tool Hang Example

In this example, a robot must perform a tool hang task, in which the robot must assemble a structure by inserting a first piece into a base and then placing a second piece on top of the first piece. The two pieces are placed relative to the base, and the base never moves. The task includes four segments, where the TAMP system grasps each piece and approaches the insertion point while the human handles each insertion. For initial conditions, the components of the structure may be placed anywhere in a predefined workspace.

In this example, the robot is a robot acting in a discrete-time Markov Decision Process (MDP) [symbol] X, U, T(x′|x, u), R(x), P₀ [symbol] defined by state space X, action space U, transition distribution T, reward function R, and initial state distribution P₀. An offline dataset of N partial demonstration trajectories is provided. The offline dataset may be collected using the HITL-TAMP system discussed herein and may include the set of human demonstrations 610. A TAMP policy πₜ(u|x) may be used for controlling the robot. The TAMP policy may plan a sequence of actions that will be tracked using a high-frequency feedback controller. The PDDLStream planning framework, a logic-based action language that supports planning with continuous values, may be used to model the TAMP domain. States and actions may be described using predicates, Boolean functions, which can have both discrete and continuous parameters. A predicate paired with values for its parameters is called a literal. The TAMP domain may use the following parameters: o is an object, g is a 6-DoF object grasp pose, p is an object placement pose, q is a robot configuration with d DoFs, and τ is a robot trajectory comprised of a sequence of robot configurations. The planning state s is a set of true literals for fluent predicates, predicates whose truth value can change over time. The following fluent predicates are defined as follows: AtPose(o, p) is true when object o is placed at placement p; AtGrasp(o, p) is true when object o is grasped using grasp g; AtConf(q) is true when the robot is at configuration q; Empty( ) is true when the robot's end effector is empty; Attached (o, o′) is true when object o is attached to object o′. In the Tool Hang task, the robot must insert a frame into a stand and then hang a tool on the frame. The set of goal system states X_{*} is expressed as a logical formula over literals. In expressions (6) and (7), s₀ is the initial state s₀ and G is the goal formula.

$${s}_{0} = \{ AtPose ( frame , {p}_{0}^{f} ) , AtPose ( tool , {p}_{0}^{t} ) , AtPose ( stand , {p}_{0}^{s} ) , AtConf ( {q}_{0} ) , Empty ( ) \} . \qquad ( 6 )$$

$$G = Attached ( frame , stand ) ∧ Attached ( tool , frame ) ∧ Empty ( ) . \qquad ( 7 )$$

Planning actions a are represented using action schema. An action schema is defined by a 1) name, 2) list of parameters, 3) list of static (non-fluent) literal constraints (con) that valid parameter values satisfy, 4) list of fluent literal preconditions (pre) that must hold to correctly execute the action, and 5) list of fluent literal effects (eff) that specify changes to state. The move action advances the robot from configuration q₁ to q₂ via trajectory τ. The constraint Motion (q₁, τ, q₂) is satisfied if q₁ and q₂ are the start and end of τ. In the pick action, the constraint Grasp (o, g) holds if g is a valid grasp for object o, and the constraint Pose(o, p) holds if p is a valid placement for object o. The explicit constraint f(q)*g=p represents kinematics, namely that forward kinematics f from configuration q multiplied with grasp g produces pose p.
move(q₁, τ, q₂):
con: [Motion(q₁, τ, q₂)]
pre: [AtConf(q₁), Safe(τ)]
eff: [AtConf(q₂), ¬AtConf(q₁)]
pick (o, g, p, q):
con: [Grasp (o,g), Pose(o,p), [f(q)*g=p]]
pre: [AtPose(o,p), Empty( ), AtConf(q)]
eff: [AtGrasp(o,g), ¬AtPose(o,p),¬Empty( )]

To account for teleoperation by the human operator during planning of the task, an approximate model of the teleoperation process may be used. Constraint learning for TAMP may be used by specifying an action schema for each skill identifying which constraints can be modeled using classical techniques (using the TAMP system). Then, the remaining constraints may be extracted from a handful of teleoperation trajectories, such as the set of human demonstrations 610. The frame insertion and tool hang may be teleoperated in the Tool Hang task.

The attach action models any skill that involves attaching one movable object to another object, for example, by placing, inserting, or hanging. Its parameters are a held object o, the current grasp g for o, the corresponding current pose p of o, the current robot configuration q, the subsequent pose \hat{p} of o, the subsequent robot configuration \hat{q}, and the object to be attached to o′. The attach action is stochastic as the human teleoperator “chooses” the resulting pose \hat{p} and configuration \hat{q}, which is modeled by the constraint HumanAttach (o, \hat{p}, \hat{q}, o′). Rather than explicitly model this constraint, an optimistic determinization of the outcome may be taken by assuming that the human produces a satisficing \hat{p}, \hat{q} pair, without committing to specific numeric values.
attach (o, g, p, q, \hat{p}, \hat{q}, o′):
con: [AttachGrasp(o, g), PreAttach(o, p, o′), [f(q)*g=p], GoodAttach(o, \hat{p}, o′), HumanAttach (o, \hat{p}, \hat{q}, o′)]
pre: [AtGrasp(o, g), AtConf(q)]
eff: [AtPose(o, \hat{p}), Empty( ), Attached(o, o′), AtConf(\hat{q}), ¬AtGrasp(o, g), ¬AtConf(q)]

The key constraint in this example is GoodAttach(o, \hat{p}, o′), which is true if object o at pose p satisfies the groundtruth goal attachment condition in G with object o′. The human teleoperator is tasked with reaching a pose p that satisfies this constraint, which is a postcondition of the action. A set of human demonstrations, such as the set of human demonstrations 610, may be used to learn the preconditions that facilitate the human operator in reaching the pose \hat{p}.

To complete the action model, the AttachGrasp and PreAttach constraints are learned, which involve parameters in attach's preconditions. These constraint models can be bootstrapped from a few (˜3) human demonstrations, such as the set of human demonstrations 610. These human demonstrations only need to showcase the involved action, which is only a small component of a task. But through compositionality, these actions can be deployed in many new tasks without the need for retraining. In some examples where the set of objects is fixed, a distribution over poses per task and objects may be learned. In some examples where there are novel objects at test time, these affordances across objects can be estimated directly from observations. PreAttach(o, p, o′) is true if p is a pose for object o immediately prior to the human operator achieving GoodAttach(o, \hat{p}, o′). For each human demonstration, the system starts at the first state where GoodAttach is satisfied and then searches backward in time for the first state where (1) the robot is holding object o and (2) objects o and o′ are at least δ centimeters apart. This minimum distance constraint ensures that o and o′ are not in contact in a manner that is spatially consistent and robust to perception and control error. The relative pose p between o and o′ may be logged as a data point. This process may be iterated over human demonstrations to populate a dataset P_{o′}^{o}={p|PreAttach(o, p, o′)}. Similarly, AttachGrasp(o, g) is true if g is a grasp for object o which allows for the human achieving GoodAttach(o, \hat{p}, o′). Not all object grasps enable the human to satisfy the target condition, for example, a frame grasp on the tip that needs to be inserted. Similar to PreAttach, for each human demonstration the relative pose between the robot end effector and object o at the first pre-contact state before satisfying GoodAttach may be logged as a data point, producing dataset G°={g|AttachGrasp(o, g)}.

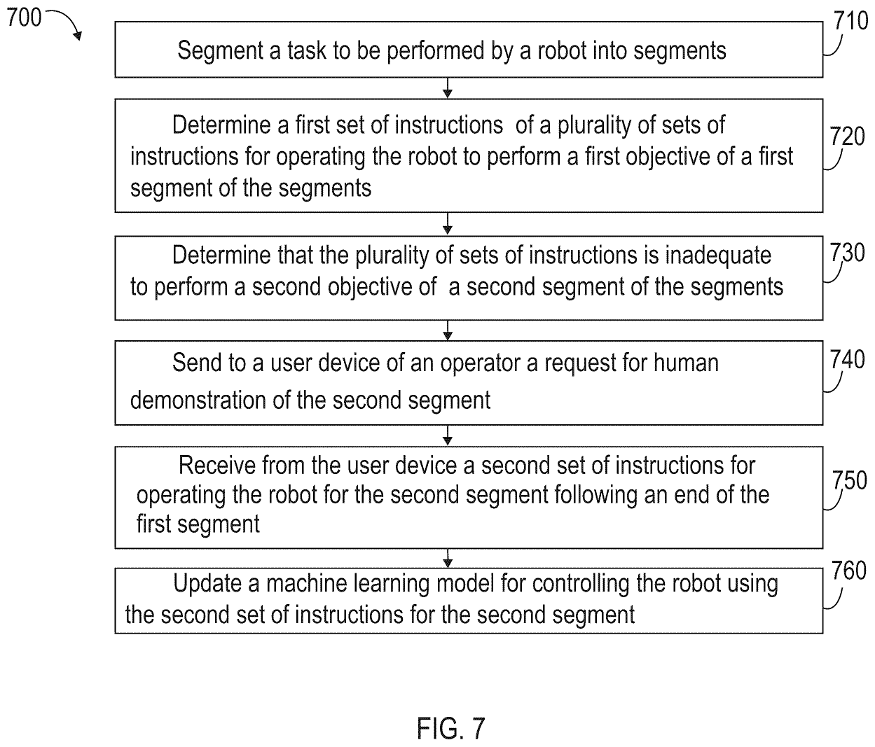

FIG. 7 is a flowchart illustrating operations of an example method 700 for training a machine learning model in accordance with at least some embodiments of the present disclosure. The method 700 may be performed by the system 100 of FIG. 1, or one or more components of the system 100 of FIG. 1. The method 700 may include more, fewer, or different operations than shown. The operations may be performed in the order shown, in a different order, or concurrently.

At 710, a task to be performed by a robot is segmented into segments. The task may be segmented into segments as discussed in conjunction with FIG. 2. The task may be segmented into segments based on actions to be taken with respect to different objects. The task may be segmented based on types of motion required of the robot within the segments. The task may be segmented based on TAMPs-controlled segments and human-controlled segments.

At 720, a first set of instructions of a plurality of sets of instructions are determined for operating the robot to perform a first objective of a first segment of the segments. The plurality of sets of instructions may include coordinates and vectors for controlling the robot. The plurality of sets of instructions may include predetermined skills for performing motions or objectives.

At 730, it is determined that the plurality of sets of instructions is inadequate to perform a second objective of a second segment of the segments. The second objective may include moving an object from a first pose to a second pose. The plurality of sets of instructions may be inadequate to perform the second objective based on the plurality of sets of instructions being inadequate to control the robot to move the object from the first pose to the second pose without contacting a second object. The plurality of sets of instructions may be inadequate to perform the second objective based on the plurality of sets of instructions being inadequate to control the robot to move the object from the first pose to the second pose within a predetermined period of time. The plurality of sets of instructions may be inadequate to perform the second objective based on the plurality of sets of instructions being inadequate to control the robot to move the object from the first pose to the second pose with a predetermined level of precision.

At 740, a request for human demonstration of the second segment is sent to a user device of an operator. The request for human demonstration of the second segment may be sent to the user device using a queueing system such as the queuing system 500 of FIG. 5. The second segment may be added to a queue of segments for which demonstration is requested. The queue of segments may be associated with a human operator. The second segment may be added to the queue of segments based at least on an expected throughput of the human operator. The second segment may be added to the queue of segments based on a duty cycle of the human operator, as discussed herein.

The first objective of the first segment may include reaching a transition pose for transitioning between the first segment and the second segment. The transition pose may be determined by mapping the segments to a human demonstration of the task and identifying one or more poses of the robot at a portion of the human demonstration corresponding to a transition from the first segment to the second segment. The transition pose may be determined by identifying one or more constraints for transitioning between the first segment and the second segment. The transition pose may be determined by identifying one or more poses from which the human operator can accomplish the second objective of the second segment. For example, the transition pose may be include a grip pose of a tool to be hung on a structural member, as discussed herein in the Tool Hang example.

The segments may include a plurality of transition poses for transitioning to segments associated with human demonstrations. In an example, each TAMP-controlled segment may include a transition pose for passing control to the human operator. The plurality of transition poses may be predefined. The plurality of transition poses may be predefined, with variances and/or tolerances.

At 750, a second set of instructions for operating the robot for the second segment following an end of the first segment is received from the user device. The human operator may input the second set of instructions in real time as the human operator controls the robot to perform the second segment and perform the objective of the second segment. The user device may receive data from the robot to facilitate the input of the second set of instructions. In an example, the user device displays one or more camera feeds from the robot and receives movement instructions from the user device. In an example, the user device is a smartphone which displays a camera feed from the robot on a display of the smartphone and which receives the second set of instructions for transmission to the robot as the human operator moves the smartphone within 3D space with six degrees of freedom.

At 760, a machine learning model for controlling the robot is updated using the second set of instructions for the second segment. The machine learning model may be updated using the second set of instructions such that the machine learning model may perform the objective of the second segment. The machine learning model may be trained using one or more sets of instructions, including the second set of instructions. In some implementations, multiple machine learning models may be trained to perform objectives of various segments of the task. In some implementations, a single machine learning model may be trained to perform various segments of the task.

The method 700 may be used to train one or more machine learning models to perform various robot-performed tasks. The method 700, by combining planning methods, such as TAMP methods, and imitation learning using human demonstration, can be applied to efficiently train machine learning models to perform a wide variety of long-horizon, touch-intensive tasks.

In an example, the robot must stack three randomly-placed cubes. The task includes four total segments. The TAMP system handles grasping each cube and approaching the stack, and the human (or, once trained, the machine learning model) handles the placement of the two cubes on top of the stack. The cubes may be initialized anywhere on a work surface.

In an example, the robot must pick a nut and place it onto a peg. The nut is initialized in a small region and the peg never moves. This task consists of two segments. The TAMP system grasps the nut and approaches the peg, and the human (or, once trained, the machine learning model) inserts the nut onto the peg. The nut and peg may be initialized anywhere on a work surface.

In an example, the robot must pick up a coffee pod, insert it into a coffee machine, and close the lid. The pod starts at a random location in a small, box-shaped region, and the machine is fixed. The task has two segments. The TAMP system grasps the pod and approaches the machine, and the human (or, once trained, the machine learning model) inserts the pod and closes the lid. In some implementations of this example, the pod and the coffee machine have significantly larger initialization regions. With 50% probability, the pod is placed on the left of the table, and the machine on the right side, or vice-versa. Once a side is chosen for each, the machine location and pod location are further randomized in a significant region.

In an example, the robot must assemble a structure by inserting a first piece into a base and then placing a second piece on top of the first. The two pieces are placed around the base, but the base never moves. The tasks consists of four segments. The TAMP system grasps each piece and approaches the insertion point for each of the two pieces while the human (or, once trained, the machine learning model) handles each insertion. The two pieces may be placed anywhere in a predefined workspace.

In an example, the robot must insert an L-shaped hook into a base piece to assemble a frame, and then hang a wrench off of the frame. The L-shaped hook and wrench vary slightly in pose, and the base piece never moves. The task has four segments. The TAMP system handles grasping the L-shaped hook and the wrench, and approaching the insertion/hang points, while the human (or, once trained, the machine learning model) handles the insertions. All three pieces may be initialized anywhere in a predefined workspace.

The machine learning model updated in the method 700 may be trained in a variety of ways. In some implementations, the machine learning model is trained on low-dimension observations or image observations. This provides flexibility which is advantageous as training the machine learning model on low-dimension observations or image observations eases the burden of perception for deploying TAMP systems in the real world. Low-dimension observations include ground-truth object poses, while image observations include RGB images from a front-view camera and a wrist-mounted camera. Both observations include proprioception (end-effector pose and gripper finger width). In simulation, the image resolution may be 84×84, while in real world tasks, a resolution of 120×160 for Stack Three, Coffee, and Coffee Broad, and a resolution of 240×240 for Tool Hang may be used. Real-world agents may all be image-based, to avoid requiring motion-tracking of objects in real-world applications. The TAMP system may estimate poses at the start of each episode, or iteration of performing the task. A simple perception pipeline including RANSAC plane estimation to segment the table from the point cloud, DBSCAN to cluster objects, color-based statistics to associate objects, and Iterative Closest Point (ICP) to estimate object poses may be used. For image-based agents, apply pixel shift randomization (up to 10% of each image dimension) may be applied as a data augmentation technique.

BC-RNN with default hyperparameters with an increased learning rate of 10⁻³ may be used for policies trained on low-dimension observations to train policies from the human-demonstrated segments in each dataset.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor, comprising:
one or more circuits to perform, using one or more machine learning models, at least a first segment of a task and a second segment of a task corresponding to a robot, wherein the one or more machine learning models are trained to perform the first segment using imitation learning and the one or more machine learning models are trained to perform the second segment using other than the imitation learning.

2. The processor of claim 1, wherein the first segment of the task and the second segment of the task are performed based at least on coordinates and vectors associated with control of the robot.

3. The processor of claim 1, wherein the one or more machine learning models are trained to perform the first segment using the imitation learning based at least on a determination that other than the imitation learning was unsuccessful for learning to perform the first segment.

4. The processor of claim 3, wherein the determination that other than imitation learning was unsuccessful is based at least on the robot being unable to move an object from a first pose to a second pose within a predetermined period of time.

5. The processor of claim 3, wherein the determination that other than imitation learning was unsuccessful is based at least on the robot being unable to move a first object from a first pose to a second pose without contacting a second object.

6. The processor of claim 3, wherein the determination that other than imitation learning was unsuccessful is based at least on the robot being unable to move an object from a first pose to a second pose with a predetermined level of precision.

7. The processor of claim 1, wherein, for the second segment, human demonstration is not requested.

8. The processor of claim 1, wherein a transition pose is determined between the first segment and the second segment, the transition pose corresponding to an end or a beginning of imitation learning.

9. The processor of claim 1, wherein an indication is sent to a computing device to indicate human demonstration is required for the imitation learning based at least on a determination that other than imitation learning was unsuccessful in training the one or more machine learning models to perform the first segment.

10. A system comprising:
one or more processing units to:
segment a task to be performed by a robot into segments;
determine a first set of instructions of a plurality of sets of instructions for operating the robot to perform a first objective of a first segment of the segments;
determine that the plurality of sets of instructions is inadequate to perform a second objective of a second segment of the segments;
send to a user device of an operator a request for human demonstration of the second segment;
receive from the user device a second set of instructions for operating the robot for the second segment following an end of the first segment; and
update one or more parameters of a machine learning model for controlling the robot using the second set of instructions for the second segment.

11. The system of claim 10, wherein the plurality of sets of instructions comprises coordinates and vectors for controlling the robot.

12. The system of claim 10, wherein the second objective comprises moving an object from a first pose to a second pose.

13. The system of claim 12, wherein the plurality of sets of instructions is inadequate to perform the second objective based at least on the plurality of sets of instructions being inadequate to at least one of:
control the robot to move the object from the first pose to the second pose within a predetermined period of time;
control the robot to move the object from the first pose to the second pose without contacting a second object; or
control the robot to move the object from the first pose to the second pose with a predetermined level of precision.

14. The system of claim 10, wherein the one or more processing units are to send the request for human demonstration of the second segment by adding the second segment to a queue of segments for which demonstration is requested.

15. The system of claim 10, wherein the queue of segments is associated with a human operator, and wherein the one or more processing units are to add the second segment to the queue of segments based at least on an expected throughput of the human operator.

16. The system of claim 10, wherein the first objective of the first segment includes reaching a transition pose for transitioning between the first segment and the second segment.

17. The system of claim 16, wherein the transition pose is determined, at least in part, by:
mapping the segments to a human demonstration of the task; and
identifying one or more poses of the robot at a portion of the human demonstration corresponding to a transition from the first segment to the second segment.

18. The system of claim 16, wherein the segments include a plurality of transition poses for transitioning to segments associated with human demonstrations.

19. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for generating or presenting at least one of augmented reality content, virtual reality content, or mixed reality content;
a system for hosting one or more real-time streaming applications;
a system implemented using an edge device;
a system implemented using a robot;
a system for performing conversational AI operations;
a system implementing one or more language models;
a system implementing one or more large language models (LLMs);
a system for performing one or more generative AI operations;
a system for generating synthetic data;
a system incorporating one or more virtual machines (VMs);
a system implemented at least partially in a data center; or
a system implemented at least partially using cloud computing resources.

20. A method, comprising:
performing, using one or more machine learning models, at least a first segment of a task and a second segment of a task corresponding to a robot, wherein the one or more machine learning models are trained to perform the first segment using imitation learning and the one or more machine learning models are trained to perform the second segment using other than imitation learning.
